(19) United States
(12) Patent Application Publication
(10) Pub. No.: US 2002/0027777 A1
(43) Pub. Date: Mar. 7, 2002

(54) Headlight

(75) Inventor: Shunichi Takasu, Anjyo-shi (JP)

Correspondence Address: ARENT FOX KINTNER PLOTKIN & KAHN, 1050 CONNECTICUT AVENUE, N.W., SUITE 600, WASHINGTON, DC, 20036, US

(73) Assignee: Metro Denki Kogyo Co., Ltd.

(21) Appl. No.: 09/925,447

(22) Filed: Aug. 10, 2001

(30) Foreign Application Priority Data
Aug. 23, 2000 (JP) 2000-252991

(51) Int. Cl. F21V 21/084

(52) U.S. Cl. 362/105; 362/103; 362/800

(57) ABSTRACT

### Issues

The purpose of this invention is to make personal work easy in a dark place.

### Method of Resolution

The arm 5, which can rotate up and down, is installed on the ear pad 4 at the end of the arc-shaped head band 2, which can be fixed while being put over the head due to elastic deformation, and the LED (luminous diode) emitting white light is installed at the tip of the arm. The battery storing unit 7 and the rotary switch 9, which is connected to the battery and LED 10, are installed inside the ear pad 4. By lowering the arm, the LED 10 irradiates one's hands which are holding a book, a game machine etc.

### BACKGROUND OF THE INVENTION

### Field of Technology to Which the Invention Belongs

The present invention relates to a headlight (including a headphone light).

### Conventional Technology

When a person enjoys reading or playing a portable game machine in a dark place, a small electric light is attached to the book or the game machine, or a head lamp is used by winding a belt with a thin flash light around one's head. Also, silence is often required in a dark place, so a headphone is used when one listens to music while reading or listens to accompanying sounds while playing a game machine.

### Issues which this Invention is Intended to Resolve

It takes time to install a small light on a book or a game machine and also a lot of light leaks because the light tries to cover a whole book or a game machine by irradiation from a close vicinity. In the same manner it is difficult to put on a head lamp and there is no device to narrow down the lighting range. Besides, it is difficult to use a head lamp with a headphone because they may interfere with each other.

Accordingly, the objective of the invention described in claim 1 is to provide a headlight which makes personal work easier in a dark place.

Also, the objective of the invention described in claim 2 is to make a compact headlight so that it may be easily stored or carried, in addition to the objective described in claim 1.

Further, the objective of the invention described in claim 3 is to provide a headlight which can be stored or used by a one-touch mechanism and which can also prevent wasteful lighting, in addition to the objective described in claim 2.

Still further, the objective of the inventions described in claims 4 and 5 is to make fine adjustment of the lighting situation possible, such as the lighting range and luminosity etc., in addition to the objectives described in claims 1 to 3.

In addition to the above, the objective described in claim 6 is to give a sufficient lighting range while controlling leakage of light, providing a sufficient amount of light and further making the light compact, in addition to the objectives described in claims 1 to 5.

On the other hand, the objective of the invention described in claim 7 is to improve fixing strength as well as to provide a headphone with a light through which music etc. can be enjoyed with ease, in addition to the objectives described in claims 1 to 6.

### Means for Resolving Issues

The invention described in claim 1 provides the headlight having a luminous device on the appropriate place of an arc-shaped head band, which can be fixed by being put over one's head, due to elastic deformation, in such a way that the luminous device can irradiate one's hands holding a book or a game machine with or without an arm. Also, the invention described in claim 2 provides the headlight of claim 1, wherein the luminous device or the arm of the invention described in claim 1 are made rotatable, being able to be stored in a position following the contour of the head band, or being able to be put in a position of use, wherein light irradiates the hands holding a book or a game machine.

Further, the invention described in claim 3 provides the headlight of claim 2, wherein a rotary switch is installed in the location of the luminous device or the lever and the rotary switch is synchronized with the luminous device or the lever, such that it is turned off when the luminous device or lever are not in the position of use, or at least when they are in the storage position and connected with the luminous device.

Still further, the invention described in claim 4 provides the headlight of claims 1 to 3, wherein the luminous device or the arm can freely move right and left and stop in a given position.

In addition, the invention described in claim 5 provides the headlight of claims 1 to 4, wherein the luminous device or the arm is telescopic. Also, the invention described in claim 6 provides the headlight of claims 1 to 5, wherein the luminous device consists of an LED emitting white light.

Further, the invention described in claim 7 provides the headlight of claims 1 to 6, wherein the head band is a headphone having a speaker housing at both ends respectively.

### Embodiments of the Invention

The embodiments of the invention are described below based on the drawings.

### The first embodiment

FIG. 1(a) illustrates the headlight 1 of the first embodiment. The headlight 1 consists of an arc-shaped head band 2, an ear grip 3 at one end of the head band 2, constituting part of the head band 2, an ear pad 4 at the other end of the head band 2 and an arm 5 extending from the ear pad 4 having an LED (luminous diode) 10 at its tip etc.

The head band 2 is made of highly elastic synthetic resin formed in an arc shape, which follows the contour of an adult human head and both ends are turned slightly inward. The ear grip 3 is made of oval-shaped synthetic resin the size of an ear hole, which is covered by a cushion such as flat sponge or cloth, and to which the head hand 2 is inserted and fixed.

The ear pad 4 is made of synthetic resin, formed as a case with a thin, oval lid 12 which is large enough to cover a whole ear, having a cushion on the inner side of the outer face and a hole 6 in the front of the ear pad around half of its circumference. FIG. 1(b) illustrates the ear pad 4 without the lid 12. The ear pad 4 receives the head band 2 in the upper area of its outer face and has a battery storing unit 7 in the lower area. It also has an axis 8 installed laterally from the base edge of the arm 5 near its center area with the rotary switch 9 installed surrounding the axis 8, and the mobile part of the switch and the base of the arm 5 are joined. The rotary switch 9 is electrically connected to the wire extending from LED 10 and passing through the inside of the arm 5 (not shown in the drawing) and also to the batteries in the battery storing unit 7. When the mobile part, which can move by half the circumference from top to bottom, is in the range of about one-third from the top, electricity is on and otherwise electricity is off. A resistance 11 is installed, passing over the rotary switch 9 to prevent the LED 10 from exceeding the rated voltage.

The arm 5 is made of synthetic resin in a cylindrical shape, which is a little longer than half of the head height. The LED 10 is attached at the tip of the arm 5, in such a way that it is exposed with its lower part sealed. The LED 10 emits white light with directivity as a luminous device.

As shown in FIG. 2, the above headlight 1 can easily fit one's head by widening both ends of the head band 2, positioning the ear grip 3 and the ear pad 4 to each ear respectively, with the head band 2 over the head, due to the fixing action of elasticity which tries to restore the original space between both ends. Further, if the arm 5 is lowered, the rotary switch is on, and the LED 10 at the tip of the arm 5, which is now facing towards one's hands and in the position of use, emits white light, having directivity and irradiates the hands alone with sufficient luminosity, controlling leakage of light. In this way, as one feels good wearing the headlight and does not have to worry about the leakage of light, one can do things as one desires in a dark place, such as reading in a relaxed mood or concentrating on the operation of a small machine etc. If the arm 5 is folded up and brought to the storing position, the arm will be stored, following the contour of the head band 2, making the whole headlight compact, and the rotary switch 9 turns off as it is synchronized with the arm 5, thus the arm can be put away by one-touch operation, preventing wasteful lighting of the LED 10 and giving the battery longer life. Further, the LED 10 has simplified the structure of the headlight 1, contributing to a better fit when wearing.

The first embodiment of the present invention has the following different versions. Material for, or a forming method of, each unit is not limited to the above. For example, the head band can be made of metal, an elastic wire can be inserted into the head band, wood or natural resin can be used for material or they can be combined, or parts made of the same material can be formed in one unit. The LED can be turned on only in the position of use, turned off only in the storing position or turned on or off at half of its moving range respectively. The rotary switch can be installed on the arm side, not on the head band side or can be a push switch, either synchronized with the arm or not. The arm does not have to be supported by the axis to move up and down but it can be fixed at the lower part. Further, the arm can be installed in the center of the head band or at any position along the head band as long as it can light one's hands. It can be telescopic, as mentioned below, and its length can be changed. Still further, the LED can be installed at the end of the head band without the arm, making it face the irradiating direction or making it face the irradiating direction when desired.

Also, the layout of the receiving unit, the battery storing unit, the axis etc. of the head band can be varied. The shape of the ear grip or the ear pad etc. can also be varied, such as one with a turn up part or in a rectangular shape. The battery storing unit can be a separate unit by ensuring electrical connection by an electric wire and putting it in a chest pocket. Also, the type and number of batteries can be varied depending on a luminous body and the power source can be a power source for home use or a power generator, instead of a battery. Still further, the circuit structure can be changed by omitting a resistance or adding a transistor or a semi-conductor electronic circuit etc.

In addition, the head band can be put on the head in various positions, such as wearing it around the back of the head, positioning it in such a way that its end comes to the back of the ear or at the upper area of the back of the ear. Also, the head band can be made smaller for children, can be telescopic in one or more places, can be folded, as mentioned below, and can be rotatable near the center to bring the right and left sides together. On the other hand, the luminous device can have an LED with lens or a cover, a miniature bulb can be used instead of the LED, although a miniature bulb is inferior in directivity and a amount of light, or light of any other color such as blue, red, green and yellow, can be used instead of white light, as long as a sufficient amount of light is obtained or plural LEDs can be combined to obtain a sufficient amount and different colors of light.

### The Second Embodiment

FIG. 3 and FIG. 4(a) illustrate the second embodiment of the headphone light (headlight) 21. The headphone light 21 consists of a head band 22, speaker units 23, 23 installed at both ends as part of the head band 22 and a luminous unit 24 as a luminous device installed on the outside of one speaker unit 23 etc.

The head band 22 is formed in the same way as the simple head band 2 except having inwardly folding parts 25, 25 and the ear pad 3 etc. being a speaker unit 23. Also, each speaker unit 23 has a speaker housing 26 made of one-unit synthetic resin from under the folded part 25, a speaker 27 inside the speaker housing 26 and a cushion 28, which covers the speaker 27 inside of the outer part by the folded and molded end part being fixed to the speaker housing 26, for example by being bonded or closely held to the speaker housing. The wires coming from each speaker 27 (see FIG. 5) are guided downward, emerge from the lower wall of the speaker housing 26, are brought together further down and are connected to one speaker terminal. An axis hole 29 is formed in the outside center of one of the speaker housings 26.

The axis 30 installed at the base end of the housing 40 of the luminous unit 24 is supported by the axis hole 29. The push button 31 in the center of the simple head band, is in the housing 40 and the battery lid 32, which is opened or closed by a grip, is also installed on the opposite side of the axis 30. Further, as shown in FIG. 4(b), the projections 33, 33 are installed inside the battery lid 32 and the batteries 34, 34 are installed in each projection 33.

Further, a push switch 35 connected with the push button 31 is installed beside each battery 34, 34 respectively and the terminals 36, 37 which are in contact with each side of the batteries 34, 34 are projected from the push switch 35. In addition, the LED 38 emitting white light is connected to the push switch 35 and the resistance 39 is placed between the terminal 36 and the LED 38.

The tip of the housing 40 is in a structure to receive the rotating axis 41 in a back and forth (longitudinal) direction and the rotating unit 42 is linked to the housing 40 via the rotating axis 41. The tip of the rotating unit 42 is a lens 43 and the head of the LED 38 is fixed within the lens 43.

As shown in FIG. 5, the above headphone light 21 can be put on easily like headphones and because the cushion 28 attaches to each ear, its fitting strength is high, with a feeling of comfort and with dislocation being prevented. If the speaker terminal is connected to the sound output terminal of the mobile game machine G, one can listen to sound etc. through the speakers 27, 27 via the speaker housing 26 and the cushion 28, without bothering one's neighbors. Further, by rotating the luminous unit 24 around the axis 30 in such a way that the lens 43 turns towards one's hands and pushing the push button 31, the bright white light of the LED 38 reaches the mobile game machine G alone via the lens 43. Thus one can enjoy playing with a game, using both one's senses of vision and hearing or one can read or do some light work while listening to music or the radio.

In addition, the rotating unit 42 can be rotated right and left by the rotating axis 41 for fine adjustment of the lighting range. The rotating unit 42 is quite tightly attached to the housing 40 along with the rotating axis 41, so that it stops in a given position and stays there, unless it is moved by hand. It can be moved to the position shown by a two-point chain line, as shown in FIG. 3, due to its shape in relation to the housing. The axis 30 has an area which comes in contact with either of the projections 33, 33 when the luminous unit 24 is in the position to light the hands (see FIG. 4(a)) or when it is in the storing position (see FIG. 3), following the contour of the head band 22 (including the speaker unit 23) with the lens 43 in the upper position and the rotating range of the luminous unit is fixed from the position of use to the storage position. When the luminous unit is put in the storage position and folded in the folding area 25, the headphone light 21 becomes compact and easy to store or carry.

The second embodiment has the following different versions, in addition to the same different versions as those of the first embodiment. The rotating unit or the rotating axis can be in one unit with the housing. Various rotating ranges do not have to be restricted. A rotary switch can be used instead of the push switch. Wiring can be changed as appropriate, for example, a wire attached to the speaker can go through the inside of the head band and emerge from one side alone. Or a wireless unit can be internalized in the head band and sound can be transmitted or light switched on or off by wireless. Further, the speaker, its wiring or the cushion can be omitted. The speaker housing can have a large resonance space for high quality sound transmission.

### The Third Embodiment

FIG. 6 illustrates the third embodiment of the headphone light (headlight) 51. The headphone light 51 is formed mostly in the same manner as that of the second embodiment except the rotating axis 41 and the rotating unit 42 are replaced by the arm 52. The tip of the arm 52 is bent like a hook, wherein plural LEDs 53, 53 . . . are installed in a row, to the right and left and are directions covered by the cover 54. The base of the cylindrical arm 52 is stored in the cylindrical unit formed near the inner center of the housing 55. It is telescopic but secured so that it will not fall off.

This type of headphone light 51 can easily be put on and bright, directive lighting can easily be obtained by plural LEDs 53, 53 . . . Also, fine adjustment for the lighting range or luminosity etc. is possible due to the telescopic arm 52. The third embodiment has several different versions, as for each of the above embodiments.

### Benefits of the Invention

Out of the present inventions, the invention described in claim 1 has the effect of lighting only one's hands just by putting on the head band because the luminous device is installed on the head band as a headlight. Thus personal work can easily be done in a dark place and one does not have to pay attention to one's surroundings.

The invention described in claim 2 has the effect of making the headlight compact easily, and making it easy to store or carry because the luminous device or the arm can be folded, in addition to the effects of the invention of claim 1.

Further, the invention described in claim 3 has the effect of providing good case of operation and preventing wasteful lighting of the invention of claim 2 by installing the on-off switch which is synchronized with the folding of the unit, in addition to the effects of the invention of claim 2.

Still further, the invention described in claim 4 enables the luminous device of the invention of claims 1 to 3 to move right and left and the invention described in claim 5 enables the luminous device of the invention of claims 1 to 4 to be moved closer or further away. Therefore these inventions have the effect of enabling the fine adjustment of each lighting situation by changing the irradiating direction or distance, in addition to the effects of the above inventions.

In addition, the invention described in claim 6 has the effect of providing light with sufficient luminosity and directivity of the invention of claims 1 to 5, which is good for carrying out work in a dark place, in addition to the effects of the invention of claims 1 to 5 because LED irradiating white light is included in the luminous device of the invention of claims 1 to 5.

On the other hand, the invention described in claim 7, in addition to the effects of the invention in claim 1 to 6, combines headlight and headphones, being worn on both ears and thus having the effect of preventing any dislocation during long use and introducing the sense of hearing while taking the surroundings into account, and thereby expanding the range of work possible in a dark place, improving work quality and alleviating fatigue.

### BRIEF DESCRIPTION OF THE DRAWINGS

FIG. 1 is an illustration of the headlight relating to the first embodiment (a) and a partial inside illustration of the first embodiment (b).

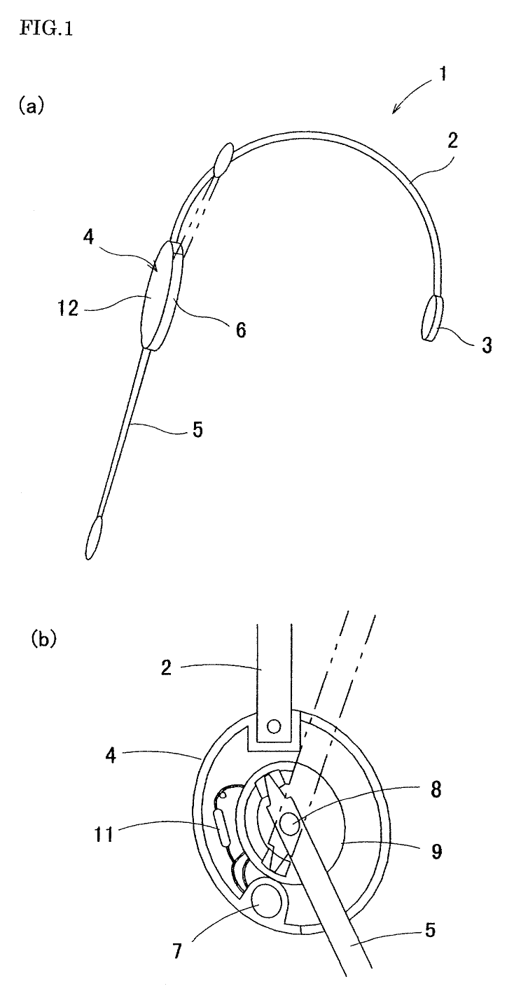

FIG. 2 is an illustration showing how the headlight is used.

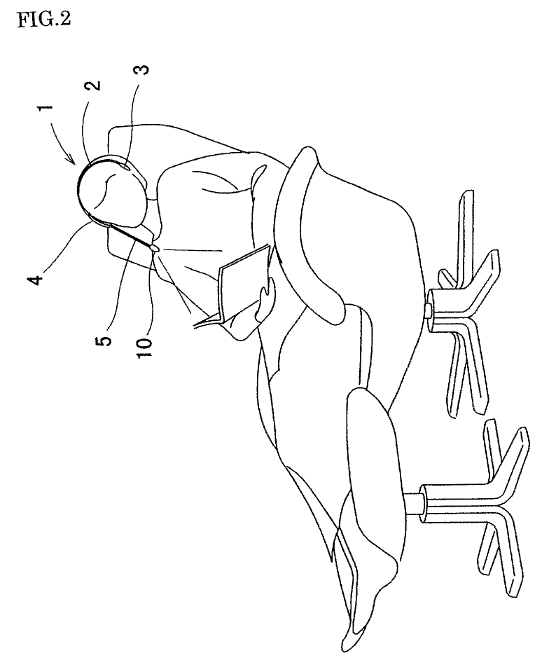

FIG. 3 is a cross sectional view of the headphone light of the second embodiment.

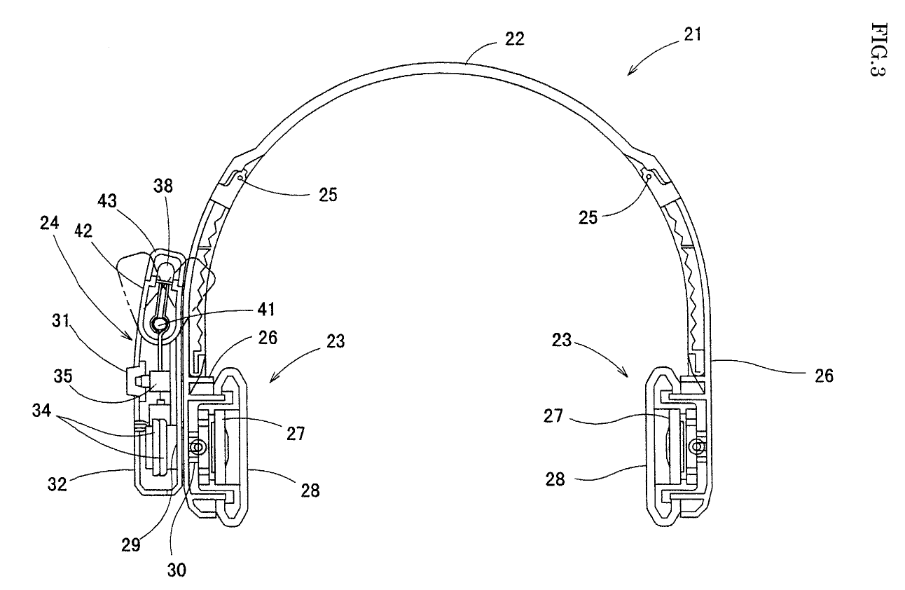

FIG. 4 is a side view of the headphone light (a) and a cross sectional view of the luminous unit of the headphone light (b).

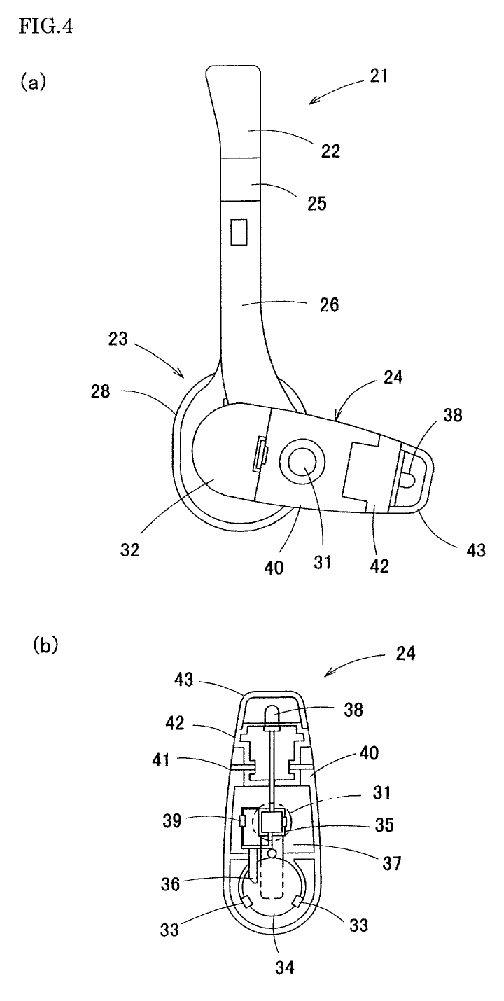

FIG. 5 is an illustration showing how the headphone light is used.

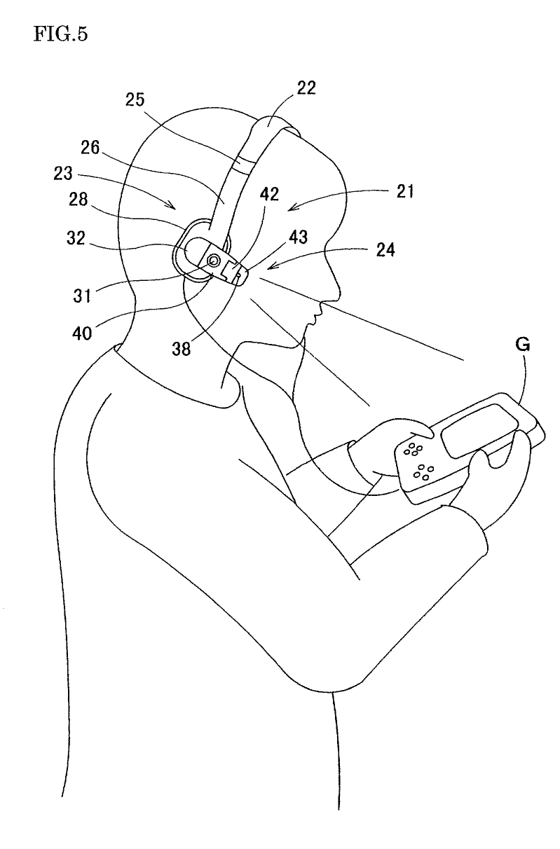

FIG. 6 is an illustration showing how the headphone light of the third embodiment is used.

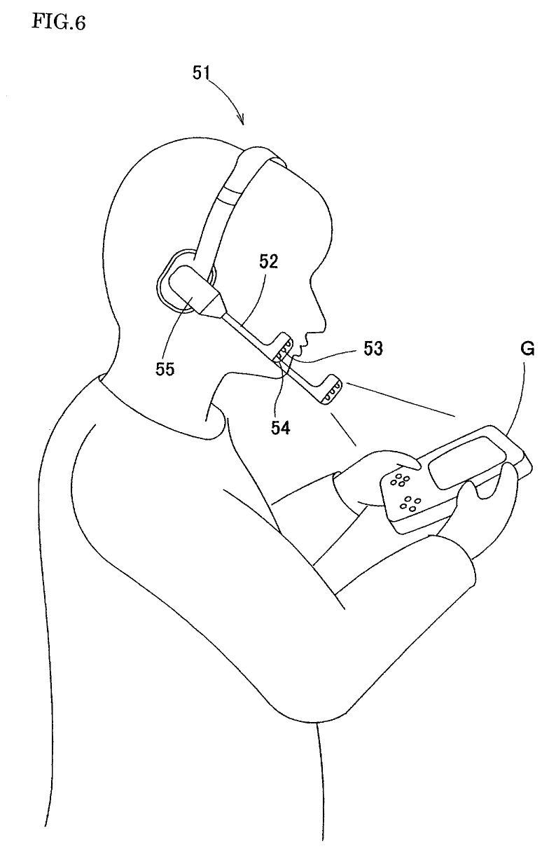

### EXPLANATION OF CODING SCHEME

1—Headlight

2, 22—Head band

3—Ear grip

4—Ear pad

5, 52—Arm

6—Hole

7—Battery storing unit

8, 30—Axis

9—Rotary switch

10, 38, 53—LED

11, 39—Resistance

12—Lid

21, 51—Headphone light

23—Speaker unit

24—Luminous unit

25—Folding unit

26—Speaker housing

27—Speaker

28—Cushion

29—Axis hole

31—Push button

32—Battery lid

33—Projection

34—Battery

35—Push switch

36,37—Terminal

40, 55—Housing

41—Rotating axis

42—Rotating unit

43—Lens

54—Cover

We Claim

1. A headlight consisting of a luminous device installed in the appropriate position on an arc-shaped head band which can be fixed while being put over the head due to elastic deformation, with or without an arm to irradiate light toward one's hands.

2. The headlight in accordance with claim 1, wherein the luminous device or the arm can rotate in such a way that either of them stops in the storing position, following the contour of the head band and in the position of use where irradiation goes toward one's hands.

3. The headlight in accordance with claim 2, wherein a rotary switch is installed, which is connected with the luminous device and synchronized with the luminous device or the lever, such that the rotary switch is turned off when the luminous device or lever are not in the position of use, or at least when they are in the storage position.

4. The headlight in accordance with either of claims 1 to 3, wherein the luminous device or the arm can rotate right and left and stop in a given position.

5. The headlight in accordance with either of claims 1 to 4, wherein the luminous device or the arm is telescopic.

6. The headlight in accordance with either of claims 1 to 5, wherein the luminous device is an LED emitting white light.

7. The headlight in accordance with either of claims 1 to 6, wherein the head band is a headphone having a speaker housing on both ends.
